(19) United States
(12) Patent Application Publication
(10) Pub. No.: US 2026/0094006 A1
(43) Pub. Date: Apr. 2, 2026

(54) METHOD FOR MODEL TRAINING, RESOURCE MANAGEMENT METHOD FOR MODEL TRAINING AND RELATED DEVICES

(71) Applicant: QUECTEL WIRELESS SOLUTIONS CO., LTD., Shanghai (CN)

(72) Inventors: Ling LYU, Shanghai (CN); Zheng ZHAO, Shanghai (CN)

(21) Appl. No.: 19/410,582

(22) Filed: Dec. 5, 2025

Related U.S. Application Data
(63) Continuation of application No. PCT/CN2024/115161, filed on Aug. 28, 2024.

(51) Int. Cl. G06N 3/098

(52) U.S. Cl. CPC G06N 3/098

(57) ABSTRACT

A method for model training, a resource management method for model training, and related devices are provided. One example method for model training includes: receiving a first sub-model from a global model, wherein the first sub-model is determined according to a first split layer; and training the first sub-model; wherein the global model further comprises a second sub-model, and at least one of the following is true: training of the first sub-model and training of the second sub-model are jointly used to determine a first local model, and the first split layer is determined according to a capability of the first terminal device; or training duration of the first sub-model is used to determine whether a training round in which the first local model participates in model aggregation is a current training round

### CROSS-REFERENCE TO RELATED APPLICATIONS

This application is a continuation of International Application No. PCT/CN2024/115161, filed on Aug. 28, 2024, the disclosure of which is hereby incorporated by reference in its entirety.

### TECHNICAL FIELD

This application relates to the technical field of wireless communications, and more particularly to a method for model training, a resource management method for model training, and related devices.

### BACKGROUND

As communication technologies evolve, the fusion of edge computing and artificial intelligence enables the exploitation of edge resources for distributed intelligent services. Training artificial intelligence models in edge networks through various learning approaches can yield high-performance intelligent models.

However, conventional training methods may either underutilize the powerful computing capabilities of base stations or incur significant latency overhead. Therefore, how to efficiently train artificial intelligence models remains a problem to be solved.

### SUMMARY

The present application provides a model training method, a resource management method for model training, and related devices. The following will introduce various aspects involved in the embodiments of the present application.

In a first aspect, a method for model training is provided, including: receiving, by a first terminal device, a first sub-model from a global model, wherein the first sub-model is determined according to a first split layer; and training, by the first terminal device, the first sub-model; where the global model further includes a second sub-model, and training of the first sub-model and training of the second sub-model are jointly used to determine a first local model, the first split layer is determined according to a capability of the first terminal device, and/or training duration of the first sub-model is used to determine whether a training round in which the first local model participates in model aggregation is a current training round.

In a second aspect, a method for model training is provided, including: transmitting, by a network device, a first sub-model from a global model to a first terminal device, wherein the first sub-model is determined according to a first split layer; and training, by the network device, a second sub-model in the global model; wherein training of the first sub-model and training of the second sub-model are jointly used to determine a first local model, the first split layer is determined according to a capability of the first terminal device, and/or training duration of the first sub-model is used to determine whether a training round in which the first local model participates in model aggregation is a current training round.

In a third aspect, a resource management method for model training is provided, including: decoupling a process of the model training into individual training rounds; and determining a first constraint condition for each of the individual training rounds; wherein the first constraint condition is used to determine a first management solution, the first management solution comprises a plurality of split layers corresponding to a plurality of terminal devices that perform the model training, the plurality of terminal devices comprise a first terminal device, the plurality of split layers comprise a first split layer corresponding to the first terminal device, and the first split layer is related to a capability of the first terminal device.

In a fourth aspect, a device for model training is provided, wherein the device for model training is a first terminal device, and the first terminal device comprises: a receiving unit, for receiving a first sub-model from a global model, wherein the first sub-model is determined according to a first split layer; and a processing unit, for training the first sub-model; wherein the global model further includes a second sub-model, and training of the first sub-model and training of the second sub-model are jointly used to determine a first local model, the first split layer is determined according to a capability of the first terminal device, and/or training duration of the first sub-model is used to determine whether a training round in which the first local model participates in model aggregation is a current training round.

In a fifth aspect, a device for model training is provided, wherein the device for model training is a network device, and the network device comprises: a transmitting unit, for transmitting a first sub-model from a global model to a first terminal device, wherein the first sub-model is determined according to a first split layer; and a processing unit, for training a second sub-model in the global model; wherein training of the first sub-model and training of the second sub-model are jointly used to determine a first local model, the first split layer is determined according to a capability of the first terminal device, and/or training duration of the first sub-model is used to determine whether a training round in which the first local model participates in model aggregation is a current training round.

In a sixth aspect, a resource management device for model training is provided, including: a first processing unit, for decoupling a process of the model training into individual training rounds; and a second processing unit, for determining a first constraint condition for each of the individual training rounds; wherein the first constraint condition is used to determine a first management solution, the first management solution comprises a plurality of split layers corresponding to a plurality of terminal devices that perform the model training, the plurality of terminal devices comprise a first terminal device, the plurality of split layers comprise a first split layer corresponding to the first terminal device, and the first split layer is related to a capability of the first terminal device.

In a seventh aspect, a communications device is provided, comprising a memory and a processor, wherein the memory is configured to store a program, and the processor is configured to call the program stored in the memory to perform the method as described in any one of the first to third aspects.

In an eight aspect, a device is provided, comprising a processor for invoking a program from a memory to perform the method as described in any one of the first to third aspects.

In a ninth aspect, a chip is provided, comprising a processor for invoking a program from a memory to cause a device installed with the chip to perform the method as described in any one of the first to third aspects.

In a tenth aspect, a computer-readable storage medium is provided, having a program stored thereon, wherein the program causes a computer to perform the method as described in any one of the first to third aspects.

In an eleventh aspect, a computer program product is provided, comprising a program, wherein the program causes a computer to perform the method as described in any one of the first to third aspects.

In a twelfth aspect, a computer program is provided, wherein the computer program causes a computer to perform the method as described in any one of the first to third aspects.

In the embodiments of the present application, the first terminal device trains the first sub-model from the global model, and this training result, along with the training result of the second sub-model from the global model, jointly determines the first local model corresponding to the first terminal device. The first split layer for determining the first sub-model is established based on the capability of the first terminal device, and/or, the training duration of the first sub-model is used to determine whether the first local model participates in the model aggregation of the current training round. In the current training round of the global model, the way the split layer is associated with capabilities of the terminal device and the way the training results from terminal devices might not participate in model aggregation both account for the differences in model training by various terminal devices, thereby improving training efficiency.

### BRIEF DESCRIPTION OF THE DRAWINGS

FIG. 1 is a schematic diagram of a wireless communications system applied in embodiments of the present application.

FIG. 2 is a flowchart of a method for model training according to embodiments of the present application.

FIG. 3 is a schematic diagram of a possible implementation of the method shown in FIG. 2.

FIG. 4 is a flowchart of a possible implementation of the method shown in FIG. 2.

FIG. 5 is a flowchart of a resource management method for model training according to embodiments of the present application.

FIG. 6 is a flowchart of a possible implementation of the method shown in FIG. 5.

FIG. 7 is a schematic structural diagram of a device for model training according to embodiments of the present application.

FIG. 8 is a schematic structural diagram of a device for model training according to other embodiments of the present application.

FIG. 9 is a schematic structural diagram of a resource management device for model training according to embodiments of the present application.

FIG. 10 is a schematic block diagram of a communications device according to embodiments of the present application.

### DETAILED DESCRIPTION OF THE EMBODIMENTS

The technical solutions in the embodiments of the present application will be described below in conjunction with the accompanying drawings of the embodiments of the present application. The described embodiments are only a part of the embodiments of the present application, and not all embodiments. All other embodiments obtained by those of ordinary skill in the art based on the embodiments in the present application without inventive efforts shall fall within the protection scope of the present application.

The embodiments of the present application can be applied to various communications systems. For example, the embodiments of the present application can be applied to global system of mobile communication (GSM) systems, code division multiple access (CDMA) systems, wideband code division multiple access (WCDMA) systems, general packet radio service (GPRS), long term evolution (LTE) systems, advanced long term evolution (LTE-A) systems, new radio (NR) systems, evolved NR systems, LTE-based access to unlicensed spectrum (LTE-U) systems, NR-based access to unlicensed spectrum (NR-U) systems, NTN systems, universal mobile telecommunications systems (UMTS), wireless local area networks (WLAN), wireless fidelity (WiFi), and 5th-generation (5G) communications systems. The embodiments of the present application can also be applied to other communications systems, such as future communications systems. Such future communications systems can include, for example, 6th-generation (6G) mobile communications systems, or satellite communications systems, and so on.

Traditional communications systems support a limited number of connections and are relatively easy to implement. However, with the development of communication technologies, communications systems can now support not only traditional cellular communications but also one or more other types of communications. For example, a communications system can support one or more of the following communications: device-to-device (D2D) communications, machine-to-machine (M2M) communications, machine type communications (MTC), enhanced machine type communications (eMTC), vehicle-to-vehicle (V2V) communications, and vehicle-to-everything (V2X) communications, etc. The embodiments of the present application can also be applied to communications systems that support the aforementioned communications methods.

The communications system in the embodiments of this application can be applied to carrier aggregation (CA) scenarios, dual connectivity (DC) scenarios, and standalone (SA) networking scenarios.

The communications system in the embodiments of this application can be applied to unlicensed spectrum. This unlicensed spectrum can also be considered shared spectrum. Alternatively, the communications system in the embodiments of this application can also be applied to licensed spectrum. This licensed spectrum can also be considered dedicated spectrum.

The embodiments of this application can be applied to an NTN system. For example, the NTN system can include a 4G-based NTN system, an NR-based NTN system, an Internet of Things (IoT)-based NTN system, and a narrow band Internet of Things (NB-IoT)-based NTN system.

The communications system may include one or more terminal devices. The terminal device mentioned in the embodiments of this application may also be referred to as user equipment (UE), an access terminal, a user unit, a user station, a mobile station, a mobile station (MS), a mobile terminal (MT), a remote station, a remote terminal, a mobile device, a user terminal, a terminal, a wireless communications device, a user agent, or a user apparatus.

In some embodiments, the terminal device may be a STATION (ST) in the WLAN. In some embodiments, the terminal device may be a cellular phone, a cordless phone, a session initiation protocol (SIP) phone, a wireless local loop (WLL) station, a personal digital assistant (PDA) device, a handheld device with a wireless communication function, a computing device, or another processing device connected to a wireless modem, an in-vehicle device, a wearable device, a terminal device in a next-generation communications system (e.g., an NR system), or a terminal device in a future evolved public land mobile network (PLMN) network.

In some embodiments, the terminal device may be a device that provides voice and/or data connectivity to a user. For example, the terminal device may be a handheld device, an in-vehicle device, or the like that has a wireless connection function. In some specific examples, the terminal device may be a mobile phone, a Pad, a notebook computer, a laptop computer, a mobile internet device (MID), a wearable device, a virtual reality (VR) device, an augmented reality (AR) device, a wireless terminal in industrial control, a wireless terminal in self-driving, a wireless terminal in a remote medical surgery, a wireless terminal in a smart grid, a wireless terminal in a transportation safety, a wireless terminal in a smart city, a wireless terminal in a smart home, or the like.

In some embodiments, the terminal device may be deployed on land. For example, the terminal device may be deployed indoors or outdoors. In some embodiments, the terminal device may be deployed on a surface, for example, on a ship. In some embodiments, the terminal device may be deployed in the air, such as on aircraft, balloons and satellites.

In addition to the terminal device, the communications system may further include one or more network devices. The network device in the embodiments of this application may be a device used to communicate with a terminal device, and the network device may also be referred to as an access network device or a radio access network device. The network device may be, for example, a base station. The network device in the embodiments of this application may be a radio access network (RAN) node (or device) that accesses a radio network by using a terminal device. The base station may broadly cover various names in the following, or may be replaced with the following names: a node B (NodeB), an evolved NodeB (eNB), a next-generation base station (next generation NodeB, gNB), a relay station, a transmitting and receiving point (TRP), a transmit point (TP), a master station (MeNB), a secondary station (SeNB), a multimode radio (MSR) node, a home base station, a network controller, an access node, a wireless node, an access point (AP), a transmit node, a transceiver node, a baseband unit (BBU), a remote radio unit (RRU), an active antenna unit (AAU), a remote radio head (RRH), a central unit (CU), a distributed unit (DU), a positioning node or the like. The base station may be a macro base station, a micro base station, a relay node, a donor node, or the like, or a combination thereof. The base station may further refer to a communications module, a modem, or a chip that is configured to be disposed in the foregoing device or apparatus. The base station may further be a mobile switching center, a device that undertakes a base station function in D2D, V2X, and M2M communications, a network side device in a 6G network, a device that undertakes a base station function in a future communications system, or the like. The base station may support a network of same or different access technologies. A specific technology and a specific device form used by the network device are not limited in the embodiments of this application.

The base station may be stationary or mobile. For example, a helicopter or drone may be configured to act as a mobile base station, and one or more cells may be moved according to the location of the mobile base station. In other examples, a helicopter or drone may be configured as a device for communicating with another base station.

In some deployments, the network device in this embodiment of this application may refer to a CU or an DU, or the network device includes a CU and an DU. The gNB may further include an AAU.

By way of example rather than limitation, in the embodiments of the present application, the network device may have mobility characteristics, for example, the network device may be a mobile device. In some embodiments of the present application, the network device may be a satellite or a balloon station. In some other embodiments, the network device may also be a base station deployed on land, over water, or at other locations.

In the embodiments of the present application, the network device may serve a cell. A terminal device may communicate with the network device via transmission resources (e.g., frequency domain resources, or spectrum resources) used by the cell. The cell may correspond to the network device (e.g., a base station). The cell may belong to a macro base station or to a base station corresponding to a small cell. The small cell may include, for example, a metro cell, a micro cell, a pico cell, or a femto cell. These small cells are characterized by limited coverage and low transmission power, and are suitable for providing high-rate data transmission services.

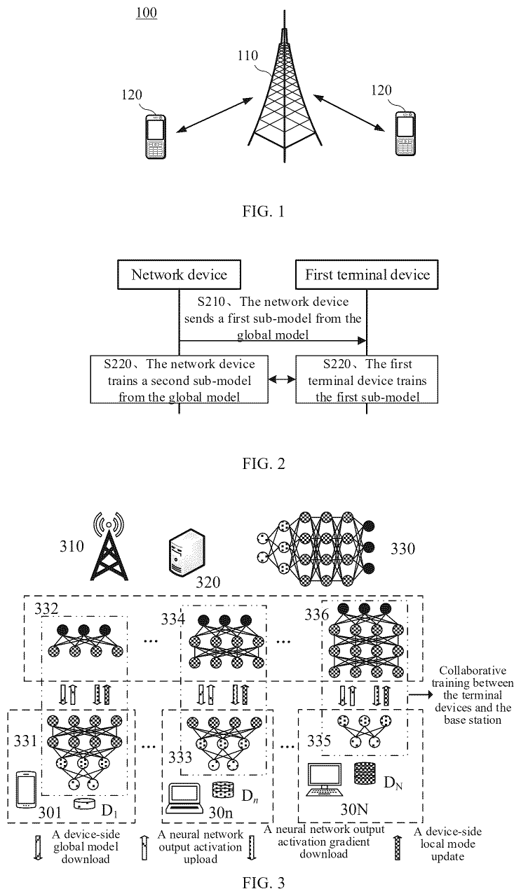

For example, FIG. 1 is a schematic architecture diagram of a communications system according to embodiments of this application. As shown in FIG. 1, the communications system 100 may include a network device 110, which may be a device that communicates with the terminal device 120 (or referred to as a communications terminal or a terminal). The network device 110 may provide communication coverage for a specific geographical area, and may communicate with a terminal device located in the coverage area.

FIG. 1 exemplarily illustrates one network device and two terminal devices. In some embodiments of the present application, the communications system 100 may include multiple network devices, and a coverage of each network device may include other numbers of terminal devices. The embodiments of the present application are not limited in this regard.

In embodiments of the present application, the communications system shown in FIG. 1 may further include other network entities such as a mobility management entity (MME) and an access and mobility management function (AMF). The embodiments of the present application are not limited in this regard.

It should be understood that, in the embodiments of the present application, a device in the network/system that has communication functionality may be referred to as a communications device. Taking the communications system 100 illustrated in FIG. 1 as an example, the communications device may include the network device 110 and the terminal device 120, both of which have communication capabilities. The network device 110 and the terminal device 120 may be the specific devices described above and will not be repeated here. The communications device may also include other devices in the communications system 100, such as a network controller, the mobility management entity, and other network entities. The embodiments of the present application are not limited in this regard.

In order to facilitate a detailed explanation of the innovative aspects of the technical solutions, some relevant technical knowledge related to the embodiments of the present application will first be introduced. The following related technologies are optional and may be combined in any manner with the technical solutions of the present application. All of these are within the scope of protection of the embodiments of the present application. The embodiments of the present application include at least a portion of the following content.

As communication technologies continue to advance, the performance requirements for artificial intelligence (AI) models in intelligent services are becoming increasingly demanding. For instance, driven by the vision of ubiquitous intelligence in 6G networks, the integration of edge computing and AI has rapidly progressed, leveraging edge resources to support distributed intelligent services. Examples of such services include autonomous driving, smart transportation, and object detection. The edge resources used to deliver these services include, for example, edge computing, communication, and storage.

Edge computing can enable edge devices in a network to train artificial intelligence (AI) models, leading to the development of high-performance intelligent models. However, efficiently obtaining high-performance intelligent models remains a critical challenge, particularly for resource-constrained wireless networks. Resource constraints may include limitations in the computing power and storage capacity of edge devices, as well as limitations in wireless resources.

Currently, the methods for training artificial intelligence (AI) models in edge networks mainly include federated learning, split learning, and federated split learning. The following provides an explanation of these three learning methods, using the example of base stations and terminal devices training deep neural networks for artificial intelligence models.

Federated learning, as a distributed intelligence paradigm, can train artificial intelligence model to enable intelligent services. Typically, the federated learning paradigm in edge networks consists of one base station and multiple terminal devices. The federated learning process is divided into multiple training rounds. In a given training round, the federated learning process includes the following steps S11 to S13.

In step S11, the base station broadcasts the global model to all terminal devices. The global model is a deep neural network.

In step S12, all terminal devices train the global model in parallel use their local datasets to obtain respective local models, and then transmit their local models to the base station via wireless channels.

In step S13, the base station aggregates the local models transmitted by all terminal devices to obtain a new global model.

The base station and terminal devices repeat the steps S11 to S13 until the global model meets the preset convergence criteria, at which point federated learning is completed.

As can be seen from steps S11 to S13, in federated learning, terminal devices are required to perform the complete training of an artificial intelligence model. However, terminal devices with limited resources (such as computing power and storage) are unable to handle the training of large artificial intelligence models. Furthermore, the base station is only responsible for aggregating the local models uploaded by the terminal devices, and its powerful computing capabilities are not fully utilized, leading to a waste of its computational power.

Split learning, as another distributed intelligence paradigm, is primarily aimed at training artificial intelligence models in resource-constrained wireless networks to enable intelligent services. The split learning paradigm in edge networks also consists of a base station and multiple terminal devices. Additionally, the base station is equipped with an edge server that has powerful computing capabilities. Typically, the split learning process is also divided into multiple training rounds. In a given training round, the terminal devices, the base station and its edge server perform the following steps S21 to S27.

In step S21, the edge server divides the global model (a deep neural network) into a device-side global model and a server-side global model. The device-side global model is the global model located on the terminal device side. The splitting point used to divide the global model can be referred to as the cut layer.

In step S22, the base station transmits the device-side global model to a terminal device. The server-side global model is placed in the edge server to assist the terminal device in training the global model.

In step S23, the terminal device that receives the global model uses its local dataset to perform forward propagation (FP) of the device-side global model, obtaining the output activations of the neural network. The output activations, for example, may be the output feature vectors (smashed data, SD). The terminal device can transmit the output activations of the neural network and the corresponding data labels to the base station via a wireless channel.

In step S24, the edge server continues to perform forward propagation and backward propagation (BP) of the server-side global model, obtaining the output activation gradient of the neural network.

In step S25, the base station transmits the output activation gradient of the neural network to the terminal device, while the edge server updates the server-side global model to obtain the local server-side model.

In step S26, the terminal device performs backward propagation and updates the device-side global model to obtain the local device-side model.

In step S27, the terminal device transmits the local device-side model to the base station via the wireless channel. The base station, acting as a relay, sends the local device-side model to a next terminal device. When all terminal devices have completed one round of training, a training round is considered complete.

The model training device repeats the process of steps S21 to S27 until the global model meets the preset convergence criteria, at which point split learning is completed.

As can be seen from steps S21 to S27, in split learning, the base station and terminal devices perform collaborative training of the global model serially. However, in this approach, only one terminal device interacts with the base station at any given time, while the remaining terminal devices remain idle. This leads to a significant amount of distributed idle resources being underutilized, and also results in substantial latency overhead.

Federated split learning, as a hybrid distributed intelligence paradigm, enables efficient training of artificial intelligence models in resource-constrained wireless networks to facilitate intelligent services. The federated split learning paradigm in edge networks also consists of a base station and multiple terminal devices. To implement split learning, the base station is equipped with an edge server that has powerful computing capabilities. The federated split learning process is typically divided into multiple training rounds. In a given training round, the terminal devices, the base station and its edge server perform the following steps S31 to S37.

In step S31, the edge server divides the global model (a deep neural network) into a device-side global model and a server-side global model.

In step S32, the base station broadcasts the device-side global model to all terminal devices. The server-side global model is replicated into copies equal to the number of terminal devices to assist each terminal device in training the global model.

In step S33, all terminal devices use their local datasets to perform forward propagation of their device-side global models in parallel, obtaining the output activations of the neural network. Each terminal device transmits the output activation of the neural network and corresponding data labels to the base station via a wireless channel.

In step S34, the edge server continues to perform forward propagation and backward propagation of the server-side global model for each terminal device, obtaining the output activation gradient of the neural network.

In step S35, the base station transmits the output activation gradient of the neural network to each terminal device, while the edge server updates the server-side global model for each terminal device, obtaining the local server-side model.

In step S36, all terminal devices perform backward propagation of the device-side global model in parallel and update the device-side global model to obtain the respective local device-side models. All terminal devices transmit their local device-side models to the base station via a wireless channel.

In step S37, the edge server combines the local device-side model and the local server-side model for each terminal device to form a local model, and performs aggregation of the local models to obtain the global model.

The model training device repeats the process of steps S31 to S37 until the global model meets the preset convergence criteria, at which point federated split learning is completed.

As can be seen from steps S31 to S37, in federated split learning, all terminal devices perform training on device-side models of the same size. Due to the variability in terminal device resources, terminal devices with strong computing capabilities are not fully utilized in the training of the artificial intelligence model. Additionally, the edge server must wait for all terminal devices to complete their local training before performing the aggregation of the global model. In other words, the latency of each round depends on the slowest terminal device, which leads to significant latency overhead.

Furthermore, in wireless communications, time-varying wireless channels and the allocation of wireless resources can also affect the training quality of the global model. The allocation of wireless resources, such as bandwidth and computational frequency, is an example of such resources. Due to the rapid variation of wireless channels, wireless resources may not be allocated reasonably, thus failing to ensure efficient long-term training of the artificial intelligence model. This issue is particularly pronounced in wireless networks with resource limitations and heterogeneous device capabilities, where the quality of model training is more susceptible to degradation. For example, while wireless channels and resource allocation may remain relatively stable during a single training round, it is difficult to maintain this stability over multiple rounds, thus preventing the guarantee of efficient long-term training.

To solve the problems existing in the various model training methods described above, the present application provides a method for model training. This method takes into account the differences in terminal device resources and makes full use of the powerful computing capabilities of a base station to perform model training tasks, thereby improving training efficiency while ensuring the performance of the global model training. For ease of understanding, the method for model training is described in detail below with reference to FIG. 2.

FIG. 2 illustrates the interactions from the perspective of the first terminal device and the network device. The first terminal device refers to a terminal device, as previously described, that has a certain level of computing and communication capability. In some embodiments, the first terminal device may train a model based on local data samples. The model may be an artificial intelligence or machine learning model. In some embodiments, the first terminal device may transmit data samples and/or a computational model to the network device. In some embodiments, the first terminal device may receive a computational model transmitted by the network device.

In an example, the network device may broadcast an artificial intelligence model to the first terminal device.

In some embodiments, the first terminal device may be any terminal device within the edge network. The first terminal device may store various data samples. Exemplarily, the data samples stored in the first terminal device may include local data samples used for training the model.

The first terminal device may be any one of multiple terminal devices participating in model training. For example, the multiple terminal devices may collaboratively train the artificial intelligence model with the network device. Each of the terminal devices may provide data samples for model training.

The network device may be any type of communications device described above that provides service to multiple terminal devices. In some embodiments, the network device is a communications device with powerful computing capabilities. For example, the network device may be the base station that broadcasts the global model to multiple terminal devices based on federated learning, or the base station that assists the multiple terminal devices in training the global model based on split learning, without limitation thereto.

In some embodiments, the network device is equipped with an edge server having powerful computing capabilities to participate in model training. In an example, the edge server may be used to determine at least one of the following types of information under a first constraint condition: a communication bandwidth of each terminal device performing model training; a manner in which the computing frequency of the edge server is allocated; a selection of multiple terminal devices for determining a first aggregation cycle; and multiple split layers including a first split layer. The first constraint condition and various types of information will be described in detail below in conjunction with FIG. 5.

The network device may communicate with multiple terminal devices including the first terminal device. In some embodiments, the network device may receive data samples or intermediate data from model training sent by the multiple terminal devices. In some embodiments, the network device may transmit, to the multiple terminal devices, the global model, sub-models obtained by splitting, and/or intermediate data from model training for a given training round.

Referring to FIG. 2, in Step S210, the first terminal device receives a first sub-model from the global model. In some embodiments, the first sub-model received by the first terminal device may originate from the network device, as illustrated in FIG. 2. In some embodiments, the first sub-model received by the first terminal device may originate from a third-party device assisting the network device in model training.

In an example, the third-party device may be a server deployed outside the base station and capable of communicating with the first terminal device.

The global model can be any artificial intelligence/machine learning model that supports intelligent services, and this application does not limit the type of global model. The types of global models include, but are not limited to: convolutional neural network models, recurrent neural network models, long short-term memory networks, and so on.

In some embodiments, the global model may be determined by the network device. For example, when performing federated split learning on the global model, the network device needs to aggregate the distributed learning results from multiple terminal devices to determine the global model for the current training round.

The global model can be the model obtained after completing the training in the previous training round. The training method for the global model typically includes multiple training rounds. A training round can refer to a single round of training or learning process, also known as an epoch. For example, in the federated learning described earlier, a single training round is used to complete the process of steps S11 to S13. Similarly, in the split learning described earlier, a single training round is used to complete the process of steps S21 to S27. Additionally, in the federated split learning described earlier, a single training round is used to complete the process of steps S31 to S37.

In an example, the training process of the global model can be decoupled based on Lyapunov optimization to optimize the training performance. Any training round in the training process of the global model can be based on any single training round derived from this decoupling.

In some embodiments, the global model can be split and trained based on split learning or federated split learning methods. The global model can be split into at least one sub-model. In other words, the global model can consist of multiple sub-models after being split.

In an example, after the global model is split, the multiple sub-models can be trained by different devices to improve training efficiency. A sub-model, after being split to be trained by a terminal device, can be referred to as the device-side global model. A sub-model after split to be trained by a server can be referred to as the server-side global model.

It should be understood that the training of the global model needs to be performed based on the local data of the terminal device, so the device-side global model typically includes an input side for data samples. The terminal device can input local data through the input side of the device-side global model and perform forward propagation. Additionally, on the device-side global model, the terminal device can also obtain the trained local model through backward propagation.

In some embodiments, for split learning or federated split learning, the training rounds of the global model can be set primarily based on the training cycles of either the terminal device side or the server side. For example, a training round may mainly include the communication duration and training duration on the terminal device side.

In an example, from the terminal device side, a training round may exclude the time taken for model aggregation on the server side. This is because the server typically has strong computational capabilities, making the time required for model aggregation relatively negligible.

In some embodiments, a training round may be divided into multiple training cycles and communication cycles. In other words, both training duration and communication duration need to be considered within a training round. For terminal devices, the communication cycle may refer to an uplink cycle and/or a downlink cycle.

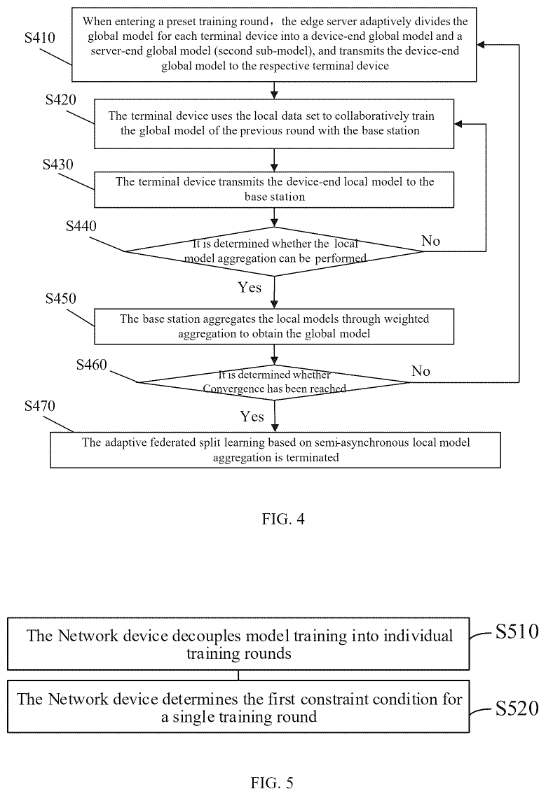

In an example, in federated split learning, the base station and terminal devices collaboratively train the global model for T training rounds, where T is a positive integer. A training round may include a device-side global model download cycle, H collaborative training cycles between the terminal devices and the base station, and a device-side local model upload cycle, where H is a positive integer. The device-side global model download cycle, the collaborative training cycles, and the device-side local model upload cycle are performed sequentially. Taking the training of a neural network as an example, each collaborative training cycle between a terminal device and the base station includes: a forward propagation sub-cycle at the terminal device, a neural network output activation upload sub-cycle, a forward and backward propagation sub-cycle at the edge server, a neural network output activation gradient download sub-cycle, and a backward propagation sub-cycle at the terminal device. These sub-cycles are performed sequentially. These cycles and sub-cycles will be illustrated below with reference to FIG. 4.

Optionally, the duration of each cycle in a training round depends on the resources of the terminal device, the wireless channel conditions, the communication and computing capabilities of the base station, the adaptive partitioning scheme of the global model, and the semi-asynchronous aggregation strategy of the local models.

In some embodiments, during the training of the model, the global model in step S210 may be the global model applied in any training round. That is, the global model may be a model trained during any training round. In some embodiments, the global model may be a model determined in a training round prior to the current training round. That is, except for the final training round in which the model converges, the global model may be a model determined upon completion of training in any other training round.

The training of the global model is jointly performed by the network device and multiple terminal devices, including the first terminal device. In the embodiment of the present application, the network device may broadcast the sub-models obtained by splitting the global model to multiple terminal devices, allowing all terminal devices participating in the model training to receive the sub-models being trained in the current training round.

The sub-model received by the first terminal device is the first sub-model from the global model. The first sub-model is a sub-model obtained by splitting the global model for the first terminal device. The first sub-model can also be referred to as the device-side global model corresponding to the first terminal device.

The first sub-model is determined based on the first split layer. In other words, for the first terminal device, the global model is split at the first split layer. The portion to be trained by the first terminal device is the first sub-model.

In an example, when the first terminal device is the n^{th} terminal device among N terminal devices performing model training, the first split layer can be denoted as lₙ. Here, N is an integer greater than or equal to 1 (i.e., a positive integer), and 1≤n≤N.

In some embodiments, the respective split layers corresponding to at least two terminal devices participating in the training are different. In other words, at least two terminal devices among the multiple terminal devices participating in the training receive different sub-models. As a result, it can be seen that the sub-models to be trained by different terminal devices are different, which helps address the issue of varying training durations caused by differences in the computation/storage capabilities of the terminal devices. This, in turn, reduces training delays caused by the heterogeneity of the terminal devices.

In some embodiments, the first terminal device is one of the multiple terminal devices performing model training. The multiple terminal devices receive multiple sub-models, each of which is determined based on the global model and a unique split layer. Therefore, the multiple sub-models include the first sub-model, and the multiple split layers include the first split layer. In an example, the multiple split layers correspond one-to-one with the multiple terminal devices. In another example, the multiple split layers correspond to the multiple terminal devices in a one-to-many relationship.

In an example, different sub-models can refer to differences in the size of the sub-models. For instance, the number of computational layers in the sub-models corresponding to two terminal devices may differ. Alternatively, the bit size of the quantized sub-models corresponding to two terminal devices may differ.

In some embodiments, the first splitting layer can be determined based on the capability of the first terminal device, thereby dividing the global model differently for multiple terminal devices according to their varying capabilities. For example, the first splitting layer can be determined based on the capability level corresponding to the first terminal device. For example, the second terminal device performing model training corresponds to the third sub-model, if the capability level of the first terminal device is higher than that of the second terminal device, the first sub-model will be larger than the third sub-model.

In an example, all terminal devices performing model training can be divided into multiple terminal device sets based on their capability levels. Terminal devices within the same terminal device set correspond to the same capability level. For instance, the first terminal device belongs to a first terminal device set, and all terminal devices within this first terminal device set correspond to the same capability level.

In some embodiments, the first split layer can be determined based on the number of data samples of the first terminal device, thereby reducing differences in training duration caused by variations in the number of data samples. The number of data samples refers to the quantity of dataset samples. For example, the first split layer can be determined based on the range in which the number of dataset samples corresponding to the first terminal device falls. For instance, the number of dataset samples of the first terminal device is within a first range, and the number of dataset samples of the second terminal device performing model training falls within a second range. When the lower limit of the first range is greater than or equal to the upper limit of the second range, the first sub-model is smaller than the third sub-model corresponding to the second terminal device.

In some embodiments, the first split layer can be determined based on the wireless resource status between the first terminal device and the network device. The wireless resource status may include one or more parameters such as communication bandwidth, channel environment, and channel quality. For example, the edge server can adaptively determine the first split layer for the first terminal device based on wireless resource status for the first terminal device, thereby splitting the global model.

In some embodiments, the first split layer can be determined by considering a combination of the above factors to balance the impact of various factors. It should be understood that the process of determining the split layer by the network device based on one or more of these factors can be dynamically adjusted, also known as an adaptive process.

After the global model is split at the first split layer, the portion to be trained on the network device side is the second sub-model. The network side can train the second sub-model via a server. Therefore, the second sub-model can also be referred to as the server-side global model corresponding to the first terminal device. The first sub-model and the second sub-model can form the global model. In other words, the global model consists of the first sub-model and the second sub-model.

In some embodiments, the first terminal device performing step S210 can represent the start of the current training round. In other words, as the start of each training round, the network device sends the first sub-model from the global model to the first terminal device.

In step S220, the first terminal device trains the first sub-model. Accordingly, the second sub-model corresponding to the first sub-model in the global model is trained on the network device side. In an example, the first terminal device and the network device train two sub-models from the global model respectively, and exchange intermediate parameters, thereby achieving collaborative training of the global model.

In an example, the first terminal device can use stochastic gradient descent to collaboratively train the global model with the base station.

In some embodiments, the first terminal device can train the first sub-model based on a part or all of the data samples from the dataset. The dataset can be a locally collected dataset or can include other data, which is not specifically limited here.

The dataset samples of the first terminal device can include, but are not limited to, images, audio, signals, etc. This embodiment is not limited by these examples.

In some embodiments, the network device trains the second sub-model based on the intermediate data uploaded by the first terminal device, and sends the training parameters of the second sub-model to the first terminal device, so that the first terminal device can update the first sub-model.

In an example, the intermediate data uploaded by the first terminal device can be the neural network output activations, such as the SD mentioned earlier.

In an example, the intermediate data uploaded by the first terminal device can also include sample labels or device identifiers to help the network device recognize them.

In an example, the training parameters sent by the network device to the first terminal device can be the gradients of the neural network output activations.

In an example, step S220 can include an interaction process between the first terminal device and the network device. Exemplarily, the first terminal device performs forward propagation on the first sub-model, obtains the output activation either at or before the split layer, and uploads the output activation. The network device performs forward propagation and backward propagation on the second sub-model based on the output activation, obtaining a gradient of the output activation. The network device sends the gradient of the output activation to the first terminal device and updates the second sub-model to the server-side local model. The first terminal device performs backward propagation on the first sub-model based on the gradient of the output activation, thus updating the first sub-model to the device-side local model.

In some embodiments, the training of the first sub-model and the training of the second sub-model are jointly used to determine the first local model. The first local model is the local model corresponding to the first terminal device, obtained after the first terminal device and the network device collaboratively train the global model. The first local model can be used by the network device for model aggregation to obtain the updated global model.

In an example, when the first terminal device is the n^{th} terminal device, the first local model in the t^{th} training round (1≤t≤T) is expressed as

$${w}_{n , t}^{H} = {w}_{n , t}^{d , H} ⊕ {w}_{n , t}^{s , H} ,$$

where ⊕ denotes a concatenation operator.

In some embodiments, the training duration of the first sub-model is used to determine whether the training round in which the first local model participates in model aggregation is the current training round, so as to avoid the training duration of the entire model being affected by a terminal device with a relatively long training time. That is, the terminal device that performs model training may determine, based on the actual situation, whether to use the current training result for model aggregation. Alternatively, the network device may determine, based on the actual situation, whether the terminal devices participating in model aggregation include the first terminal device.

The training duration of the first sub-model may be replaced with the training duration of the global model corresponding to the first terminal device, that is, the duration of the collaborative training of the global model by the first terminal device and the network device. The training duration of the first sub-model may dynamically change along with variations in state parameters.

In some embodiments, the training duration of the first sub-model is determined based on one or more of: a location of the first split layer in the global model; the capability/a quantity of data samples of the first terminal device; a radio resource status between the first terminal device and a network device; and a calculation frequency allocated by the network device to the first terminal device.

In some embodiments, the current training round may refer to a single training round that is presently being executed. As described above, if the training round in which the first local model participates in model aggregation is the current training round, the first terminal device is one of the terminal devices participating in model aggregation in the current training round. If the training round in which the first local model participates in model aggregation is not the current training round, the first terminal device continues to train the first sub-model in one or more training rounds following the current training round. Therefore, it can be seen that the first terminal device does not need to terminate the current training. The first local model only participates in model aggregation after the training of the first sub-model is completed and the state of the first local model meets the aggregation requirements.

In an example, the state of the first local model in the current training round may be represented by a parameter to indicate whether the first local model is eligible to participate in model aggregation. For instance, when the state of the first local model is 1, the first local model participates in model aggregation in the current training round. When the state is 0, the first local model does not participate in model aggregation in the current training round. The reverse configuration may also be applied.

In some embodiments, the relationship between the training duration of the first sub-model and a first aggregation cycle is used to determine whether the first local model participates in model aggregation in the current training round. The first aggregation cycle is a parameter preset for the current training round to determine the timing of model aggregation.

In an example, when the training duration of the first sub-model exceeds the duration of the first aggregation cycle, the first local model does not participate in model aggregation in the current training round. When the training duration of the first sub-model is less than or equal to the duration of the first aggregation cycle, the first local model participates in model aggregation in the current training round. In other words, if the training duration of the first sub-model exceeds the predefined first aggregation cycle, the first local model determined by the first terminal device in the current training round will participate in model aggregation in one or more subsequent training rounds.

In some embodiments, the length of each aggregation cycle in a training round depends on the terminal devices participating in local model aggregation. In an example, the first aggregation cycle may be determined based on the states of N local models trained by N terminal devices and a first threshold. The first threshold may represent the minimum number e.g., Nₘᵢₙ, of local models required to participate in model aggregation.

For example, the assessing basis for local model aggregation may be defined as

$${\sum }_{n = 1}^{N} {m}_{n , t} \geq {N}_{m i n} ,$$

where m_{n,t} denotes the state of the local model of the n^{th} terminal device. m_{n,t}=1 indicates that the n^{th} terminal device has obtained a local model and is eligible to participate in local model aggregation, otherwise, the n^{th} terminal device does not participate in local model aggregation. Nₘᵢₙ represents the number of terminal devices that participate in local model aggregation.

In some embodiments, after performing model aggregation of the local models corresponding to all or part of the terminal devices in the current training round, the network device can obtain the global model for the next training round. The global model for the next training round can be determined based on the weighting coefficients of the multiple terminal devices that participated in model aggregation, that is, the network device performs model aggregation based on the weights. The weighted coefficient may also be referred to as the weight coefficient.

In some embodiments, the multiple weighting coefficients are determined based on the aggregation intervals of the multiple terminal devices participating in model aggregation and/or bias parameters for controlling model aggregation. The aggregation interval for model aggregation may indicate whether a terminal device participates in model aggregation in every training round. The bias parameter for controlling model aggregation may indicate the direction or objective of the model aggregation.

In an example, when the aggregation interval is 1, the terminal device participates in model aggregation in each training round. When the aggregation interval is greater than 1, the terminal device participates in model aggregation after training over multiple training rounds.

In an example, when the bias parameter is greater than 1, model aggregation can reduce the risk of the global model being trained toward terminal devices with high computing capabilities. When the bias parameter is less than 1, model aggregation accelerates the convergence of the global model at the cost of the global model being trained toward terminal devices with high computing capabilities. When the bias parameter is equal to 1, the weighted coefficient is only related to a dataset sample of the terminal device and is not affected by the heterogeneity of the terminal devices.

For example, when the current training round is the t^{th} training round among T training rounds, the global model wₜ₊₁ is expressed as

$${w}_{t + 1} = {\sum }_{n = 1}^{N} {m}_{n , t} {ρ}_{n , t} {w}_{n , t}^{H} ,$$

where 1≤n≤N, m_{n,t} represents the local model state of the n^{th} terminal device among N terminal devices in the t^{th} training round, ρ_{n,t} represents a weighted coefficient of the n^{th} terminal device in the t^{th} training round, and

$${w}_{n , t}^{H}$$

represents the local model of the n^{th} terminal device in the t^{th} training round.

When the n^{th} terminal device is one of the terminal devices in the set Sₜ participating in the model aggregation, the weighted coefficient ρ_{n,t} is expressed as

$${ρ}_{n , t} = \frac{{D}_{n} {γ}^{{α}_{n , t}}}{{\sum }_{k ∈ {S}_{t}} {D}_{k} {γ}^{{α}_{k , t}}} ,$$

where Dₙ represents the number of data samples of the n^{th} terminal device, γ represents the bias parameter that controls the model aggregation, α_{n,t} represents the aggregation interval of the n^{th} terminal device, Dₖ represents the number of data samples of the k^{th} terminal device in Sₜ, and α_{k,t} represents the aggregation interval of the k^{th} terminal device.

As shown in FIG. 2, an adaptive federated split learning paradigm is proposed in the embodiments of the present application. This method fully takes into account differences in terminal device capabilities, the number of data samples, and wireless resources. For example, the method allows terminal devices with low computing capabilities to perform fewer training tasks of the device-end global model, while terminal devices with high computing capabilities to undertake more training tasks of the device-end global model.

Further, in this method, in addition to the device-end global model, the remaining server-end global model is trained with the assistance of the network device. The collaborative training between all terminal devices and the network device is performed in parallel, thereby improving the training efficiency of the global model. Accordingly, the method for model training in the embodiments of the present application not only fully utilizes the powerful computing capability of network devices such as base stations, but also overcomes the limited resources of terminal devices in wireless networks, thereby improving the training efficiency while ensuring the performance of global model training.

To facilitate understanding, the following provides a schematic description of the adaptive federated split learning method proposed in the embodiments of the present application with reference to FIGS. 3 and 4. FIG. 3 is a schematic structural diagram of an adaptive federated split learning paradigm according to the embodiments of the present application. FIG. 4 is a schematic flow diagram of the adaptive federated split learning paradigm based on semi-asynchronous local model aggregation according to the embodiments of the present application.

Referring to FIG. 3, the federated split learning system may include 1 network device (base station 310) and N terminal devices. The base station 310 is equipped with an edge server 320 with powerful computing capabilities. The N terminal devices are a terminal device 301, . . . , a terminal devices 30n to a terminal device 30N. The three terminal devices shown in FIG. 3 correspond to different capabilities and numbers of data samples. The data set D₁ of the terminal device 301 is smaller than the data set Dₙ of the terminal device 30n, and the data set Dₙ is smaller than the data set D_{N} of the terminal device 30N. The N terminal devices and the base station can perform local collaborative training for T training rounds.

As shown in FIG. 3, in the collaborative training, the terminal device performs downloading of the device-side global model (the first sub-model), uploading of the neural network output activation, downloading of the gradient of the neural network output activation, and uploading of the device-side local model.

Referring further to FIG. 3, when entering the t^{th} training round, the base station 310 or the edge server 320 may have a global model 330, that is, wₜ. During the device-side global model download cycle, the edge server can adaptively divide the global model wₜ for the n^{th} terminal device into a device-side global model

$${w}_{n , t}^{d}$$

(i.e., a first sub-model 333) and a server-side global model

$${w}_{n , t}^{s}$$

(i.e., a second sub-model 334) according to the wireless resource status and terminal device capabilities of the terminal device. Exemplarily, the first sub-model 331 of the terminal device 301 is

$${w}_{1 , t}^{d} ,$$

and the second sub-model 332 is

$${w}_{1 , t}^{s} .$$

The first sub-model 335 of the terminal device 30N is

$${w}_{N , t}^{d} ,$$

and the second sub-model 336 is

$${w}_{N , t}^{s} .$$

Further, the base station transmits the device-end global model

$${w}_{n , t}^{d}$$

to the n^{th} terminal device, while the server-end global model

$${w}_{n , t}^{s}$$

remains at the base station.

During the τ^{th} (1≤τ≤H) collaborative training cycle between the n^{th} terminal device and the base station, the n^{th} terminal device performs forward propagation of the device-end global model

$${w}_{n , t}^{d , τ}$$

using samples from the dataset Dₙ to obtain the output activation of the neural network, and transmits it together with the corresponding sample labels to the base station. Subsequently, the edge server at the base station performs a forward pass and a backward pass of the server-end global model

$${w}_{n , t}^{s , τ}$$

to obtain the gradient of the output activation of the neural network.

The base station transmits the gradient of the output activation of the neural network to the n^{th} terminal device and updates the server-end global model

$${w}_{n , t}^{s , τ}$$

to obtain a server-end local model

$${w}_{n , t}^{s , τ + 1} .$$

The n^{th} terminal device then performs backward propagation of the device-end global model

$${w}_{n , t}^{d , τ}$$

and updates the device-end global model

$${w}_{n , t}^{d , τ}$$

to obtain a device-end local model

$${w}_{n , t}^{d , τ + 1} .$$

The above process is repeated H times to obtain a device-end local model

$${w}_{n , t}^{d , H}$$

and a server-end local model

$${w}_{n , t}^{s , H} .$$

During the device-end local model upload cycle, the n^{th} terminal device transmits the device-end local model

$${w}_{n , t}^{d , H}$$

to the base station. The edge server combines

$${w}_{n , t}^{d , H}$$

with its server-end local model

$${w}_{n , t}^{s , H}$$

to form a local model

$${w}_{n , t}^{H} .$$

Then the edge server performs model aggregation on the local models of the N terminal devices according to their respective weighting coefficients (weighted coefficients) to obtain the global model wₜ₊₁ for the next training round.

The weighting coefficient of the n^{th} terminal device can be represented as ρ_{n,t}. When the local models of all N terminal devices participate in model aggregation, ρ_{n,t} is a non-negative real number satisfying

$${\sum }_{n = 1}^{N} {ρ}_{n , t} = 1 .$$

When only part of terminal devices participate in model aggregation, ρ_{n,t} is calculated based only on these terminal devices whose local models participate in model aggregation.

Referring to FIG. 4, in step S410, when entering a preset training round, the edge server adaptively divides the global model for each terminal device into a device-end global model and a server-end global model (second sub-model), and transmits the device-end global model to the respective terminal device. The device-end global model corresponds to the first sub-model, and the server-end global model corresponds to the second sub-model.

The training process in step S410 occurs during the device-end global model download cycle. By way of example, in the t^{th} training round, when the terminal device and the base station adopt a frequency-division multiple access (FDMA) transmission method, the device-end global model download cycle for the n^{th} terminal device,

$${τ}_{n , {l}_{n} , t}^{D L} ,$$

can be determined as

$${τ}_{n , {l}_{n} , t}^{D L} = \frac{{ξ}_{n , {l}_{n}}^{d}}{{R}_{n , t}^{D L}} , where {ξ}_{n , {l}_{n}}^{d}$$

is the size of the device-end global model divided for the n^{th} terminal device at the split layer lₙ, and

$${R}_{n , t}^{D L}$$

is the downlink (DL) transmission rate of the n^{th} terminal device. Optionally,

$${R}_{n , t}^{D L}$$

can be expressed as,

$${R}_{n , t}^{D L} = {B}_{n , t} {log}_{2} ( 1 + \frac{{P}_{n , t}^{D L} {\vert {h}_{n , t} \vert}^{2}}{{N}_{0}} ) ,$$

where B_{n,t} is the communication bandwidth allocated to the n^{th} terminal device,

$${P}_{n , t}^{DL}$$

is the transmission power from the base station to the n^{th} terminal device, h_{n,t} is the wireless channel attenuation coefficient between the n^{th} terminal device and the base station, and N₀ is the additive white Gaussian noise power.

In step S420, the terminal device uses the local data set to collaboratively train the global model of the previous round with the base station. The training process occurs within collaborative training cycles between H terminal devices and base station. As mentioned above, the collaborative training cycle between every terminal device and the base station may include a forward propagation sub-cycle at the terminal device, a neural network output activation upload sub-cycle, a forward and backward propagation sub-cycle at the edge server, a neural network output activation gradient download sub-cycle, and a backward propagation sub-cycle at the terminal device. The following is an exemplary description of multiple sub-cycles.

The n^{th} terminal device adopts stochastic gradient descent to collaboratively train the global model with the base station. The forward propagation sub-cycle at the terminal device is expressed as

$${τ}_{n , {l}_{n}}^{FP} = \frac{{bC}_{{l}_{n}}^{FP}}{{f}_{n} {q}_{n}} ,$$

where b is the number of samples processed by the n^{th} terminal device during a collaborative training cycle between the n^{th} terminal device and the base station.

$${C}_{{l}_{n}}^{FP}$$

is the number of floating point operations (FLOP) considered by the n^{th} terminal device to train one data sample and perform forward propagation based on the device-end global model. fₙ is the central processing unit (CPU) frequency of the n^{th} terminal device, and qₙ is the number of FLOPs considered by the n^{th} terminal device per cycle.

After the n^{th} terminal device completes the training, the neural network output activation upload sub-cycle

$${τ}_{n , {l}_{n} , t}^{S D}$$

can be determined as

$${τ}_{n , {l}_{n} , t}^{S D} = \frac{b {ξ}_{n , {l}_{n}}^{S}}{{R}_{n , t}^{UL}} ,$$

where for the device-end global model split at the split layer lₙ for the n^{th} terminal device,

$${ξ}_{n , {l}_{n}}^{S}$$

is the size of the neural network output activation for a single sample, and

$${R}_{n , t}^{UL}$$

is the uplink (UL) transmission rate of the n^{th} terminal device. Optionally,

$${R}_{n , t}^{UL}$$

can be expressed as

$${R}_{n , t}^{UL} = {B}_{n , t} {log}_{2} ( 1 + \frac{{P}_{n , t}^{UL} {\vert {h}_{n , t} \vert}^{2}}{{N}_{0}} ) , where {P}_{n , t}^{UL}$$

is the transmission power from the n^{th} terminal device to the base station.

After the base station receives the output activation, the forward and backward propagation sub-cycle at the edge server

$${τ}_{n , {l}_{n} , t}^{s}$$

can be determined as

$${τ}_{n , {l}_{n} , t}^{s} = \frac{{bC}_{{l}_{n}}^{s}}{{f}_{n , t}^{s} {q}_{s}} ,$$

where when the edge server trains the server-end global model for the n^{th} terminal device,

$${C}_{{l}_{n}}^{s}$$

is the number of floating point operations required for performing both forward and backward propagation for a single data sample,

$${f}_{n , t}^{s}$$

is the CPU frequency allocated to the t terminal device by the edge server, and qₛ is the number of FLOPs performed by the edge server per cycle.

After the edge server determines the gradient of the output activation, the neural network output activation gradient download sub-cycle

$${τ}_{n , {l}_{n} , t}^{G}$$

can be determined as

$${τ}_{n , {l}_{n} , t}^{G} = \frac{b {ξ}_{n , {l}_{n}}^{G}}{{R}_{n , t}^{DL}} ,$$

where for the device-end global model split at the split layer lₙ for the n^{th} terminal device,

$${ξ}_{n , {l}_{n}}^{G}$$

is the size of the neural network output activation gradient corresponding to a single sample.

After receiving the gradient of the output activation, the backward propagation sub-cycle at the terminal device r

$${τ}_{n , {l}_{n}}^{B P}$$

can be determined as

$${τ}_{n , {l}_{n}}^{B P} = \frac{b {C}_{{l}_{n}}^{B P}}{{f}_{n} {q}_{n}} ,$$

where when the n^{th} terminal device trains its device-end global model with a data sample,

$${C}_{{l}_{n}}^{B P}$$

is the number of FLOPs required for the terminal device to perform backward propagation.

It should be noted that the forward propagation sub-cycle at the terminal device, the neural network output activation upload sub-cycle, the forward and backward propagation sub-cycle at the edge server, the neural network output activation gradient download sub-cycle, and the backward propagation sub-cycle at the terminal device are in a serial order. A collaborative training cycle between multiple terminal devices and the base station includes H such serial processes.

In an example, the device-end local model

$${w}_{n , t}^{d , H}$$

can be determined as

$${w}_{n , t}^{d , H} = {w}_{n , t}^{d , 0} - {η}_{t} {\sum }_{τ = 0}^{H - 1} {g}_{n , t}^{d , τ} , where {w}_{n , t}^{d , 0}$$

is the initial device-end global model (first sub-model) of the n^{th} terminal device, ηₜ is the learning rate, and

$${g}_{n , t}^{d , τ}$$

is the device-end gradient formed by the n^{th} terminal device during the τ^{th} collaborative training cycle between the terminal device and the base station.

In an example, the server-end local model

$${w}_{n , t}^{s , H}$$

can be determined as

$${w}_{n , t}^{s , H} = {w}_{n , t}^{s , 0} - {η}_{t} {\sum }_{τ = 0}^{H - 1} {g}_{n , t}^{s , τ} , where {w}_{n , t}^{s , 0}$$

is the initial server-end global model (second sub-model) provided by the edge server to the n^{th} terminal device, and

$${g}_{n , t}^{s , τ}$$

is the server-end gradient formed by the edge server for the n^{th} terminal device during the τ^{th} collaborative training cycle between the terminal device and the base station.

In step S430, the terminal device transmits the device-end local model to the base station. The uploading process of the device-end local model occurs within the device-end local model upload cycle. As an example, the device-end local model upload cycle

$${τ}_{n , {l}_{n} , t}^{UL}$$

for the n^{th} terminal device can be determined as

$${τ}_{n , {l}_{n} , t}^{UL} = \frac{{ξ}_{n , {l}_{n}}^{d}}{{R}_{n , t}^{UL}} .$$

In step S440, it is determined whether the local model aggregation can be performed. If it is determined that the local model aggregation can be performed, step S450 is performed. Otherwise, step S420 is performed. Optionally, the base station can use specific basics to determine whether local model aggregation can be performed.

In step S450, the base station aggregates the local models through weighted aggregation to obtain the global model. In an example, after receiving the device-end local model of the n^{th} terminal device, the base station combines it with the corresponding server-end local model to obtain the local model (first local model), and then performs weighted aggregation of the local models to obtain the global model.

In step S460, it is determined whether convergence has been reached. If the convergence has been reached, step S470 is performed. Otherwise, step S410 is performed. The base station can use specific basics to determine whether the global model has converged. In some embodiments, the convergence assessing basis for the global model wₜ+1 can be determined as |F(wₜ₊₁)−F(wₜ)|≤ε, where F(w) is the loss function computed based on the global model w, which can be used to measure the training performance of the global model, and ε is the preset convergence accuracy.

It should be understood that the above embodiment is merely for illustrating how to determine whether the global model has converged. In addition to the convergence assessing basis mentioned above, any basis that can determine the objective convergence of the global model can be applied in the embodiments of the present application. The embodiments of the present application are not limited in this regard.

In step S470, the adaptive federated split learning based on semi-asynchronous local model aggregation is terminated.

If determining that the global model meets the convergence condition, the base station broadcasts the device-end global model and a training termination instruction to all terminal devices. The terminal device and the edge server stop training the device-end global model and the server-end global model, respectively. Subsequently, the base station and terminal devices release the communication resources and computing resources that have been used for collaborative training.

As shown in FIGS. 3 and 4, the embodiments of the present application propose a semi-asynchronous local model aggregation strategy that accounts for the differences in device resources and the heterogeneity of wireless channels. This strategy can reduce the waiting delay for each training round and further improve the global model training efficiency. On the one hand, all terminal devices can perform local collaborative training in parallel with the base station to obtain local models. On the other hand, once the preset aggregation cycle arrives, the edge server at the base station does not need to wait for all terminal devices to complete the local collaborative training, but can directly aggregate the local models of terminal devices that have completed the training. Terminal devices that have not completed collaborative training can continue training in the next training round without being terminated or interrupted. Implementing the semi-asynchronous local model aggregation strategy can significantly reduce the training latency overhead.

The adaptive federated split learning paradigm based on semi-asynchronous local model aggregation provided in the embodiments of the present application can fully utilize the powerful computing capabilities of the network device to assist resource-constrained terminal devices in training artificial intelligence model, while maximizing the use of computing resources of the terminal devices. Therefore, this can accelerate the training efficiency of the global model while ensuring the performance. Additionally, the semi-asynchronous local model aggregation strategy can also reduce the delay overhead in the training process of the global model, thereby improving the aggregation efficiency.

The embodiments of the present application also propose an artificial intelligence model learning system. The learning system includes a network device and multiple terminal devices, where any terminal device in the multiple terminal devices performs the method by the terminal device described earlier, and the network device performs the method by the network devices described earlier.

As introduced in conjunction with FIGS. 2 to 4, the method for model training based on terminal device capabilities or training duration has been described. As noted earlier, time-varying wireless channels and wireless resource allocation also affect the quality and efficiency of training of the global model. For example, due to the rapid changes in wireless channels, the base station may be unable to make optimal global resource allocation decisions for training the artificial intelligence model.

Based on this, the embodiments of the present application also propose a resource management method for model training. This resource management can include management of wireless resources as well as management of terminal device training resources. For example, in time-varying wireless channels, this resource management method can ensure efficient global model training through an online management solution for wireless resources.

To facilitate understanding, the resource management method proposed in the embodiments of the present application is described in detail below with reference to FIG. 5. The resource management method shown in FIG. 5 can be performed by a network device such as a base station or by an edge server deployed outside the base station. This resource management method helps the model training device perform the method for model training shown in FIG. 2. For simplicity, the terms explained in FIG. 2 will not be repeated here.

Referring to FIG. 5, in step S510, the process of model training is decoupled into individual training rounds. That is, the model training task is decoupled into tasks for individual training rounds to improve training efficiency.

In some embodiments, the model training can be decoupled based on Lyapunov optimization. Lyapunov optimization is widely used in stochastic networks, and analyzes, controls, and optimizes random events, time variations, and uncertain networks, proving that time-averaged constraint optimization can be achieved in general stochastic networks.

In an example, a simple Lyapunov drift-plus-penalty framework can be used to optimize the time-averaged values of throughput, power, and distortion for the wireless network, thereby making near-optimal decisions.

Optionally, Lyapunov optimization can decouple a multi-level stochastic optimization problem into subproblems that are solved sequentially, while also providing a theoretical guarantee for the long-term stability of the network. In an example, based on Lyapunov optimization, the base station can decouple a training task of the artificial intelligence model into tasks for individual training rounds.

In some embodiments, the decoupling of model training can be determined based on Lyapunov optimization and the second constraint condition. That is, according to Lyapunov optimization and the second constraint condition, the model training process is decoupled into individual training rounds.

In an example, the second constraint condition may relate to system energy consumption. For instance, the base station can use Lyapunov optimization to decouple the training task of the global model into individual training rounds under the constraint of system energy consumption.

In step S520, the first constraint condition is determined for a single training round.

In some embodiments, the first constraint condition can be related to at least one of the following information: the duration of model training or the energy consumption of multiple terminal devices and the network device. The duration of model training is used to limit the application duration of the constraint condition. The energy consumption of multiple terminal devices and the network device is used to constrain the energy consumption of the training device during the training process. For example, the first constraint condition may be a long-term low energy consumption condition. The resource management solution determined based on the first constraint condition is used for long-term, low-energy, adaptive, and stable collaborative training of the global model.

The first constraint condition is used to determine the first management solution. The first management solution can optimize the resources of the wireless network performing the global model training task for a single training round, ensuring the optimal execution of the global model training task for that round.

In some embodiments, the first management solution may include a plan for executing the model training by multiple terminal devices, as well as a management solution for wireless resources. For example, the base station can make an optimal resource resource management plan based on the first constraint condition.

In some embodiments, the first management solution can also be determined based on the wireless network state for a single training round. Optionally, the wireless network state for a single training round can include information such as a channel state, a terminal device state, an edge server state, etc.

The first management solution includes multiple split layers corresponding to multiple terminal devices performing model training. These terminal devices include the first terminal device, and the split layers include the first split layer corresponding to the first terminal device.

In some embodiments, the first management solution may also include one or more of the following: a communication bandwidth of each terminal device performing the model training; a manner in which a calculation frequency of the edge server is allocated; and a selection of a plurality of terminal devices for determining a first aggregation cycle. For example, the resource management solution may encompass the allocation of communication bandwidth and computational frequency of the edge server, the selection of terminal devices participating in local model aggregation, and the selection of split layers for the global model.

In an example, the allocation of communication bandwidth and computational frequency of the edge server may be formulated as a convex optimization problem for a single training round, for the purpose of long-term low energy consumption for the wireless network. Further, the processing unit in the base station or server may utilize the Lagrange dual method for iterative solving, resulting in an asymptotically optimal allocation scheme for communication bandwidth and computational frequency of the edge server.

Optionally, the allocation scheme for communication bandwidth and computational frequency of the edge server may be obtained through other approaches, and the embodiments of the present application are not limited in this regard.

In another example, the selection of terminal devices participating in local model aggregation may be formulated as an integer linear programming problem for a single training round, for the purpose of long-term low energy consumption for the wireless network. Additionally, the processing unit in the base station or server may utilize the branch-and-bound algorithm for iterative solving, resulting in an asymptotically optimal selection scheme for the terminal devices involved in local model aggregation.

Optionally, the selection of terminal devices participating in local model aggregation can also be obtained through other approaches, and the embodiments of the present application are not limited in this regard.

In an example, the selection of global model split layers can be formulated as an integer optimization problem for a single training round, for the purpose of low long-term energy consumption in the wireless network. Furthermore, the processing unit in the base station or server can use exhaustive search algorithms for iterative solving, obtaining the optimal global model split layer selection scheme.

Optionally, the global model split layer selection scheme can also be obtained through other approaches, and the embodiments of the present application are not limited in this regard.

In some embodiments, the first management solution can be issued to all terminal devices performing the model training to facilitate collaborative training between multiple edge devices and complete the training task of the global model for the current training round. For example, after determining the split layers corresponding to multiple terminal devices, the network device can send the device-side global models to respective terminal devices.

In an example, in a single training round, the terminal device and the base station perform one device-side global model download sub-cycle, H collaborative training sub-cycles, and one device-side local model upload sub-cycle. As described above, each collaborative training sub-cycle includes a forward propagation sub-cycle at the terminal device, a neural network output activation upload sub-cycle, a forward and backward propagation sub-cycle at the edge server, a neural network output activation gradient download sub-cycle, and a backward propagation sub-cycle at the terminal device.

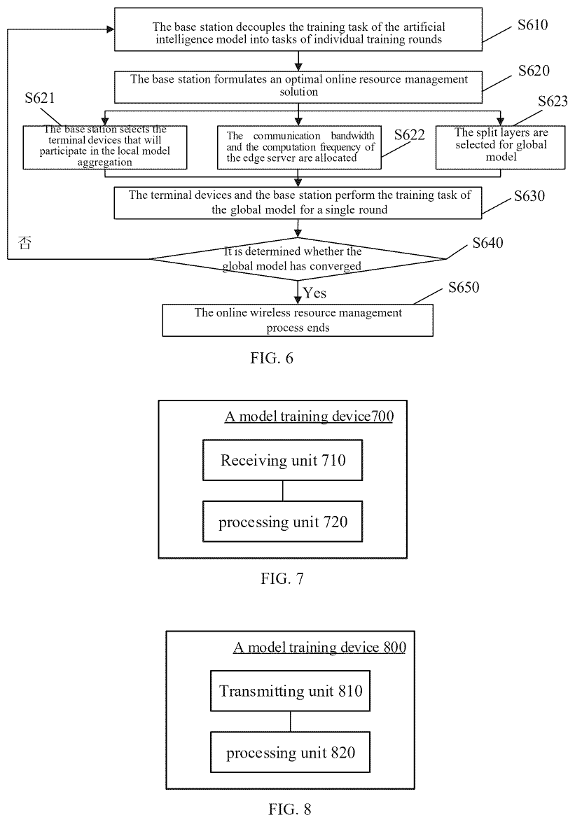

For ease of understanding, the following provides a schematic description of the wireless resource management proposed in the embodiments of the present application, which is designed to address time-varying wireless channels and ensure efficient training of the global model. The description is made by taking the base station as the executor of the resource management method for model training, and is provided in conjunction with FIG. 6.

Referring to FIG. 6, in step S610, the base station decouples the training task of the artificial intelligence model into tasks of individual training rounds.

In step S620, the base station formulates an optimal online resource management solution, which specifically includes steps S621 to S623. In step S621, the base station selects the terminal devices that will participate in the local model aggregation. In step S622, the communication bandwidth and the computation frequency of the edge server are allocated. In step S623, the split layers are selected for global model.

In step S630, the terminal devices and the base station perform the training task of the global model for a single round.

In step S640, it is determined whether the global model has converged. If the global model has converged, step S650 is performed, otherwise, the process proceeds to step S610. Optionally, the base station may apply specific basis to determine whether the global model has converged. The convergence criterion for the global model wₜ₊₁ is as previously described.

In step S650, the online wireless resource management process ends. Once determines that the global model satisfies the convergence condition, the base station broadcasts a training termination instruction to all terminal devices. The terminal device and the edge server then stop training the device-side global model and the server-side global model, respectively. Afterward, the base station and terminal devices release the wireless resources used for collaborative training.

As shown in FIGS. 5 to 6, the online wireless resource management solution provided in the embodiments of the present application can ensure efficient training of the global model even in environments with rapidly changing wireless channels. This resource management method not only achieves optimal utilization of computational and communication resources but also accelerates the training efficiency of the global model. Furthermore, the demand for energy-efficient execution of artificial intelligence model tasks by the network can be satisfied with long-term low power consumption in the wireless network as a constraint.

The above has described the method embodiments of the present application in detail with reference to FIGS. 1 to 6. The following will describe the device embodiments of the present application in detail with reference to FIGS. 7 to 10. It should be understood that the descriptions of the device embodiments correspond to those of the method embodiments. Therefore, parts not described in detail may be referred to in the preceding method embodiments.

FIG. 7 is a schematic block diagram of a model training device according to an embodiment of the present application. The model training device 700 may be a first terminal device used for model training. The first terminal device may be any of the terminal devices described above. As shown in FIG. 7, the model training device 700 includes a receiving unit 710 and a processing unit 720.

The receiving unit 710 is configured to receive a first sub-model from a global model. The first sub-model is determined based on a first split layer.

The processing unit 720 is configured to train the first sub-model. The global model further includes a second sub-model. The training of the first sub-model and the training of the second sub-model are jointly used to determine a first local model. The first split layer is determined based on the capability of the first terminal device, and/or the training duration of the first sub-model is used to determine whether the training round in which the first local model participates in model aggregation is the current training round.

Optionally, the first terminal device is one of a plurality of terminal devices. The plurality of sub-models received by the plurality of terminal devices are respectively determined based on the global model and a plurality of different split layers, wherein the plurality of sub-models include the first sub-model, and the plurality of split layers include the first split layer.

Optionally, the first split layer is determined based on the capability level corresponding to the first terminal device. A second terminal device performing model training corresponds to a third sub-model. When the capability level of the first terminal device is higher than that of the second terminal device, the first sub-model is larger than the third sub-model.

Optionally, the first terminal device belongs to a first terminal device set, and all terminal devices in the first terminal device set correspond to the same capability level.

Optionally, the first split layer is further determined based on the number of data samples of the first terminal device and/or the wireless resource status between the first terminal device and the network device.

Optionally, the training duration of the first sub-model is determined based on one or more of the following information: the location of the first split layer in the global model; the capability and/or the number of data samples of the first terminal device; the wireless resource status between the first terminal device and the network device; and the computing frequency allocated by the network device to the first terminal device.

Optionally, when the training round in which the first local model participates in model aggregation is not the current training round, the processing unit is further configured to train the first sub-model in one or more training rounds following the current training round.

Optionally, the current training round corresponds to a first aggregation cycle. When the training duration of the first sub-model is greater than the duration of the first aggregation cycle, the first local model does not participate in the model aggregation of the current training round. When the training duration of the first sub-model is less than or equal to the length of the first aggregation cycle, the first local model participates in the model aggregation of the current training round.

Optionally, the first aggregation cycle is determined based on the statuses of N local models corresponding to N terminal devices performing model training and a first threshold, where N is a positive integer.

Optionally, when the status of the first local model in the current training round is 1, the first local model participates in the model aggregation of the current training round. When the status of the first local model in the current training round is 0, the first local model does not participate in the model aggregation of the current training round.

Optionally, the model aggregation of the current training round is used to determine the global model of the next training round. The global model of the next training round is determined based on multiple weighting coefficients respectively corresponding to the multiple terminal devices participating in the model aggregation.

Optionally, the multiple weighting coefficients are respectively determined based on aggregation intervals of the multiple terminal devices participating in the model aggregation and/or a bias parameter for controlling the model aggregation.

Optionally, when the current training round is the t^{th} training round among T training rounds, the global model wₜ₊₁ is expressed as

$${w}_{t + 1} = {\sum }_{n = 1}^{N} {m}_{n , t} {ρ}_{n , t} {w}_{n , t}^{H} ,$$

where 1≤n≤N m_{n,t} represents the local model state of the n^{th} terminal device among N terminal devices in the t^{th} training round, ρ^{n,t} represents a weighted coefficient of the n^{th} terminal device in the t^{th} training round, and

$${w}_{n , t}^{H} ing$$

represents the local model of the n^{th} terminal device in the t^{th} training round.

Optionally, the n^{th} terminal device is one of the terminal devices in the set Sₜ participating in the model aggregation, the weighted coefficient ρ^{n,t} is expressed as

$${ρ}_{n , t} = \frac{{D}_{n} {γ}^{{α}_{n , t}}}{{\sum }_{k ∈ {S}_{t}} {D}_{k} {γ}^{{α}_{k , t}}} ,$$

where Dₙ represents the number of data samples of the n^{th} terminal device, γ represents the bias parameter that controls the model aggregation, α_{n,t} represents the aggregation interval of the n^{th} terminal device, Dₖ represents the number of data samples of the k^{th} terminal device in Sₜ, and α_{k,t} represents the aggregation interval of the k^{th} terminal device.

Optionally, the network device that transmits the first sub-model includes an edge server. The edge server is configured to determine, under a first constraint condition, at least one of the following information: a communication bandwidth of each terminal device performing the model training; a manner in which a calculation frequency of the edge server is allocated; a selection of a plurality of terminal devices for determining a first aggregation cycle; and multiple split layers including the first split layer.

FIG. 8 illustrates a schematic block diagram of a model training device 800 according to an embodiment of the present application. The model training device 800 may be any network device for model training as described above. As shown in FIG. 8, the model training device 800 includes a transmitting unit 810 and a processing unit 820.

The transmitting unit 810 is configured to transmit a first sub-model from a global model to a first terminal device, the first sub-model being determined based on a first split layer.

The processing unit 820 is configured to train a second sub-model in the global model. The training of the first sub-model and the training of the second sub-model are jointly used to determine a first local model. The first split layer is determined based on the capability of the first terminal device, and/or the training duration of the first sub-model is used to determine whether the first local model participates in model aggregation is the current training round.

Optionally, the first terminal device is one of a plurality of terminal devices, and the plurality of sub-models received by the terminal devices are respectively determined based on the global model and a plurality of different split layers. The plurality of sub-models include the first sub-model, and the plurality of split layers include the first split layer.

Optionally, the first split layer is determined based on a capability level associated with the first terminal device. A second terminal device performing model training corresponds to a third sub-model. When the capability level of the first terminal device is higher than that of the second terminal device, the first sub-model is larger than the third sub-model.

Optionally, the first terminal device belongs to a first terminal device set, and all terminal devices in the first terminal device set have the same capability level.

Optionally, the first split layer is further determined based on the data sample quantity of the first terminal device and/or the wireless resource status between the first terminal device and the network device.

Optionally, the training duration of the first sub-model is determined based on one or more of the following information: the location of the first split layer in the global model; the capability and/or the number of data samples of the first terminal device; the wireless resource status between the first terminal device and the network device; and the computing frequency allocated by the network device to the first terminal device.

Optionally, when the training round in which the first local model participates in model aggregation is not the current training round, the processing unit is further configured to train the second sub-model in one or more training rounds subsequent to the current training round.

Optionally, the current training round corresponds to a first aggregation cycle. When the training duration of the first sub-model is greater than the duration of the first aggregation cycle, the first local model does not participate in the model aggregation of the current training round. When the training duration of the first sub-model is less than or equal to the length of the first aggregation cycle, the first local model participates in the model aggregation of the current training round.

Optionally, the first aggregation cycle is determined based on the statuses of N local models corresponding to N terminal devices performing model training and a first threshold, where N is a positive integer.

Optionally, when the status of the first local model in the current training round is 1, the first local model participates in the model aggregation of the current training round. When the status of the first local model in the current training round is 0, the first local model does not participate in the model aggregation of the current training round.

Optionally, the model aggregation of the current training round is used to determine the global model of the next training round. The global model of the next training round is determined based on multiple weighting coefficients respectively corresponding to the multiple terminal devices participating in the model aggregation.

Optionally, the multiple weighting coefficients are respectively determined based on aggregation intervals of the multiple terminal devices participating in the model aggregation and/or a bias parameter for controlling the model aggregation.

Optionally, when the current training round is the t^{th} training round among T training rounds, the global model wₜ₊₁ is expressed as

$${w}_{t + 1} = {\sum }_{n = 1}^{N} {m}_{n , t} {ρ}_{n , t} {w}_{n , t}^{H} ,$$

where 1≤n≤N m_{n,t} represents the local model state of the n^{th} terminal device among N terminal devices in the t^{th} training round, ρ_{n,t} represents a weighted coefficient of the n^{th} terminal device in the t^{th} training round, and

$${w}_{n , t}^{H}$$

represents the local model of the n^{th} terminal device in the t^{th} training round.

Optionally, the n^{th} terminal device is one of the terminal devices in the set Sₜ participating in the model aggregation, the weighted coefficient ρ_{n,t} is expressed as

$${ρ}_{n , t} = \frac{{D}_{n} {γ}^{{α}_{n , t}}}{{\sum }_{k ∈ {S}_{t}} {D}_{k} {γ}^{{α}_{k , t}}} ,$$

where Dₙ represents the number of data samples of the n^{th} terminal device, γ represents the bias parameter that controls the model aggregation, α_{n,t} represents the aggregation interval of the n^{th} terminal device, Dₖ represents the number of data samples of the k^{th} terminal device in Sₜ, and α_{k,t} represents the aggregation interval of the k^{th} terminal device.

Optionally, the network device includes an edge server. The edge server is configured to determine, under a first constraint condition, at least one of the following information: a communication bandwidth of each terminal device performing the model training; a manner in which a calculation frequency of the edge server is allocated; a selection of a plurality of terminal devices for determining a first aggregation cycle; or multiple split layers including the first split layer.

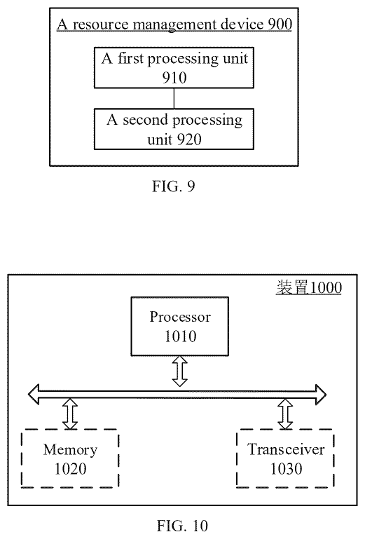

FIG. 9 is a schematic block diagram of a resource management device for model training according to an embodiment of the present application. The resource management device 900 may be any type of network device or edge server used for model training as described above. As shown in FIG. 9, the resource management device 900 includes a first processing unit 910 and a second processing unit 920.

The first processing unit 910 is configured to decouple the model training process into individual training rounds.

The second processing unit 920 is configured to determine a first constraint condition for an individual training round. The first constraint condition is used to determine a first management solution, and the first management solution includes multiple split layers respectively corresponding to multiple terminal devices performing model training. The multiple terminal devices include a first terminal device, and the multiple split layers include a first split layer corresponding to the first terminal device. The first split layer is associated with the capability of the first terminal device.

Optionally, the first processing unit 910 is further configured to decouple the model training process into individual training rounds based on Lyapunov optimization and a second constraint condition.

Optionally, the first management solution further includes one or more of the following: a communication bandwidth of each terminal device performing the model training; a manner in which a calculation frequency of the edge server is allocated; and a selection of a plurality of terminal devices for determining a first aggregation cycle.

Optionally, the first constraint condition is related to at least one of: the duration of model training; or the energy consumption of multiple terminal devices and the network device.

FIG. 10 shows a schematic structural diagram of a communications device in the embodiment of the present application. The dashed lines in FIG. 10 indicate that the unit or module is optional. The communications device 1000 can be used to implement the method described in the above method embodiments. The communications device 1000 can be a chip, terminal device, or network device.

The communications device 1000 may include one or more processors 1010. The processor 1010 can support the device 1000 to perform the method described in the previous method embodiments. The processor 1010 can be a general-purpose processor or a dedicated processor. For example, the processor can be a CPU. Alternatively, the processor may also be other general-purpose processors, digital signal processors (DSPs), application-specific integrated circuits (ASICs), field-programmable gate arrays (FPGAs), or other programmable logic devices, discrete gates or transistor logic devices, discrete hardware components, etc. A general-purpose processor may be a microprocessor or any conventional processor, etc.

The communications device 1000 may also include one or more memories 1020. The memory 1020 stores a program that can be executed by the processor 1010, enabling the processor 1010 to perform the method described in the previous method embodiments. The memory 1020 can be independent of the processor 1010 or integrated within the processor 1010.

The communications device 1000 may further include a transceiver 1030. The processor 1010 can communicate with other devices or chips via the transceiver 1030. For example, the processor 1010 can send and receive data through the transceiver 1030.

The present application further provides a computer-readable storage medium for storing a program. The computer-readable storage medium can be applied to the terminal device or the network device provided in the embodiments of the present application, and the program enables a computer to perform the method performed by the terminal device or the network device as described in the various embodiments of the present application.

The computer-readable storage medium may be any available medium that can be read by a computer, or a data storage device such as a server or a data center that incorporates one or more available media. The available media may include magnetic media, optical media, semiconductor media, and the like. Examples of the computer-readable storage medium include, but are not limited to: a phase-change random access memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc-read only memory (CD-ROM), a solid state disks (SSD), digital video discs (DVD) or other optical storage media, magnetic cassettes, a magnetic tape/magnetic disk storage, or other magnetic storage devices, or any other non-transitory medium.

The present application further provides a computer program product. The computer program product comprises a program. The computer program product may be applied to the terminal device or the network device provided in the embodiments of the present application, and the program causes a computer to perform the method performed by the terminal device or the network device as described in the various embodiments of the present application.

The foregoing embodiments of the present application may be implemented in whole or in part by software, hardware, firmware, or any combination thereof. When implemented in software, the embodiments may be embodied in whole or in part as a computer program product. The computer program product comprises one or more computer instructions. The computer program instructions, when being loaded onto and executed by a computer, cause the computer to perform all or part of the processes or functions described in the embodiments of the present application. The computer may be a general-purpose computer, a dedicated computer, a computer network, or other programmable device. The computer instructions may be stored on a computer-readable storage medium or transmitted from one computer-readable storage medium to another. For example, the computer instructions may be transmitted from one website, computer, server, or data center to another website, computer, server, or data center over a wired medium (e.g., a coaxial cable, an optical fiber, a digital subscriber line (DSL)) or a wireless medium (e.g., infrared, radio, microwave, etc.).

The present application further provides a computer program. The computer program may be applied to the terminal device or network device provided in the embodiments of the present application, and the computer program causes a computer to perform the method performed by the terminal device or network device as described in various embodiments of the present application.

The terms “system” and “network” as used herein may be used interchangeably. Furthermore, the terminology used in the present application is intended solely to describe particular embodiments of the present application and is not intended to limit the scope of the present application. The terms “first,” “second,” “third,” “fourth,” and the like as used in the description and claims of the present application and in the accompanying drawings are intended to distinguish different objects and are not intended to indicate any particular order.

It should be noted that the terms “comprise,” “include,” “have,” and any variations thereof are intended to cover a non-exclusive inclusion. For example, a process, method, article, or device that comprises a series of elements is not limited to those elements but may include other elements not expressly listed or inherent to such process, method, article, or device. Unless explicitly stated otherwise, an element defined by the phrase “comprising a . . . ” does not exclude the presence of additional identical elements in the process, method, article, or device that includes the element.

In the embodiments of the present application, the term “indicate” may refer to a direct indication, an indirect indication, or an indication of an association. For example, “A indicates B” may mean: that A directly indicates B, e.g., B being obtainable from A; that A indirectly indicates B, e.g., A indicating C and B being obtainable from C; or that A and B are associated.

In the embodiments of the present application, the term “correspond” may refer to a direct or indirect correspondence between two entities, an association between them, or a relationship such as one indicating or being indicated by the other, or one being configured with or by the other.

In the embodiments of the present application, “predefined” or “preconfigured” may be implemented by storing corresponding codes, tables, or other forms of information in advance on a device (e.g., the terminal device or network device). The present application imposes no specific limitation on the manner in which such predefined configurations are realized. For example, “predefined” may refer to definitions provided by a protocol.

In the embodiments of the present application, the term “protocol” may refer to a standard protocol in the communication field, for example, including the LTE protocol, the NR protocol, or protocols applicable to future communication systems, without limitation thereto.

In the embodiments of the present application, “determining B based on A” does not imply determining B solely based on A. Instead, B may be determined based on A and/or other information.

In the embodiments of the present disclosure, the term “and/or” is merely used to describe an association between related objects, indicating that three types of relationships may exist. For example, “A and/or B” may refer to: only A, both A and B, or only B. Additionally, the character “/” generally denotes an “or” relationship between the related objects preceding and following it.

In the embodiments of the present disclosure, the numerical labels assigned to the above-mentioned steps do not necessarily indicate the sequence of execution. The sequence of execution of the steps should be determined based on their functions and inherent logic, and should not be construed as a limitation on the implementation process of the embodiments of the present disclosure.

In the several embodiments provided in the present disclosure, it should be understood that the disclosed systems, devices, and methods may be implemented in other manners. For example, the device embodiments described above are merely illustrative. The division of the units is only one example of logical functional division. In actual implementation, other forms of division may be adopted. For example, multiple units or components may be combined or integrated into another system, or certain features may be omitted or not performed. Additionally, the couplings or direct couplings or communication connections shown or discussed between modules may be indirect couplings or communication connections through certain interfaces, devices, or units, and such connections may be electrical, mechanical, or of other types.

The units described as separate components may or may not be physically separated, and the component displayed as a unit may or may not be a physical unit. That is, the units may be located in one place or distributed across multiple network units. Some or all of the units may be selected as needed to achieve the objectives of the embodiments of the present disclosure.

In addition, the functional units in various embodiments of the present disclosure may be integrated into one processing unit, or each unit may exist independently in a physical form, or two or more units may be integrated into one unit.

Through the descriptions of the foregoing embodiments, those skilled in the art can clearly understand that the method embodiments described above may be implemented by software in combination with a necessary general hardware platform. The method embodiments described above may also be implemented by hardware. In many cases, the former is a preferable implementation. Based on such understanding, the technical solutions of the present disclosure, or at least the part contributing to the prior art, may be embodied in the form of a software product. The computer software product is stored in a storage medium (such as ROM, RAM, a magnetic disk, or an optical disk) and includes several instructions for enabling a service classification device (which may be a mobile phone, a computer, a server, an air conditioner, or a network device, etc.) to perform the methods described in the embodiments of the present disclosure. It should be noted that the serial numbers of the embodiments are provided only for descriptive purposes and do not imply any priority or preference among the embodiments.

The above-described embodiments are merely specific examples of the present application. However, the scope of the present application is not limited to these embodiments. Any variations or substitutions that would be obvious to those skilled in the art within the technical scope disclosed in this application should also fall within the scope of protection of this application. Therefore, the scope of protection of this application should be determined by the scope of the claims.

What is claimed is:

1. A method for model training, comprising:
receiving, by a first terminal device, a first sub-model from a global model, wherein the first sub-model is determined according to a first split layer; and
training, by the first terminal device, the first sub-model;
wherein the global model further comprises a second sub-model, and at least one of the following is true:
training of the first sub-model and training of the second sub-model are jointly used to determine a first local model, and the first split layer is determined according to a capability of the first terminal device; or
training duration of the first sub-model is used to determine whether a training round in which the first local model participates in model aggregation is a current training round.

2. The method for model training according to claim 1, wherein the first terminal device is one of a plurality of terminal devices, a plurality of sub-models received by the plurality of terminal devices are separately determined according to the global model and a plurality of different split layers, the plurality of sub-models comprise the first sub-model, and the plurality of split layers comprise the first split layer.

3. The method for model training according to claim 1, wherein the first split layer is determined according to a capability level corresponding to the first terminal device, a second terminal device that performs the model training corresponds to a third sub-model, and the first sub-model is greater than the third sub-model in a case of the capability level of the first terminal device being higher than a capability level of the second terminal device.

4. The method for model training according to claim 1, wherein the first terminal device belongs to a first terminal device set, and all terminal devices in the first terminal device set correspond to a same capability level.

5. The method for model training according to claim 1, wherein the first split layer is further determined according to at least one of a quantity of data samples of the first terminal device or a radio resource status between the first terminal device and a network device.

6. The method for model training according to claim 1, wherein the training duration of the first sub-model is determined according to one or more of:
a location of the first split layer in the global model;
the capability of the first terminal device or a quantity of data samples of the first terminal device;
a radio resource status between the first terminal device and a network device; or
a calculation frequency allocated by the network device to the first terminal device.

7. The method for model training according to claim 1, wherein in a case that the training round in which the first local model participates in model aggregation is not the current training round, the method further comprises:
training, by the first terminal device, the first sub-model in one or more training rounds subsequent to the current training round.

8. The method for model training according to claim 1, wherein the current training round corresponds to a first aggregation cycle, the first local model does not participate in the model aggregation in the current training round in a case that the training duration of the first sub-model is longer than duration of the first aggregation cycle; and the first local model participates in model aggregation of the current training round in a case that the training duration of the first sub-model is less than or equal to duration of the first aggregation cycle.

9. The method for model training according to claim 8, wherein the first aggregation cycle is determined according to states of N local models of the N terminal devices that perform the model training and a first threshold, and N is a positive integer.

10. The method for model training according to claim 1, wherein
the first local model participates in the model aggregation in the current training round in a case that the first local model is in a state of 1 in the current training round; or
the first local model does not participate in model aggregation of the current training round in a case that the first local model is in a state of 0 in the current training round.

11. The method for model training according to claim 1, wherein the model aggregation in the current training round is used to determine a global model of a next training round, and the global model of the next training round is determined according to a plurality of weighting coefficients corresponding to a plurality of terminal devices participating the model aggregation.

12. The method for model training according to claim 11, wherein the plurality of weighting coefficients are separately determined according to at least one of an aggregation interval at which the plurality of terminal devices participate in the model aggregation or an offset parameter for controlling the model aggregation.

13. The method for model training according to claim 11, wherein the current training round is a t^{th} training round in T training rounds, T is a positive integer, 1≤t≤T, and a global model wₜ₊₁ of a (t+1)^{th} training round is expressed as:
$${w}_{t + 1} = {\sum }_{n = 1}^{N} {m}_{n , t} {ρ}_{n , t} {w}_{n , t}^{H} ,$$
wherein 1≤n≤N, m_{n,t} represents a state of a local model of an n^{th} terminal device in the N terminal devices in the t^{th} training round, ρ_{n,t} represents a weighting coefficient of the n^{th} terminal device in the t^{th} training round, and
$${w}_{n , t}^{H}$$
represents the local model of the n^{th} terminal device in the t^{th} training round.

14. The method for model training according to claim 13, wherein the n^{th} terminal device is one in a terminal device set Sₜ participating in the model aggregation, and the weighting coefficient ρ_{n,t} of the n^{th} terminal device in the t^{th} training round is expressed as:
$${ρ}_{n , t} = \frac{{D}_{n} {γ}^{{α}_{n , t}}}{{\sum }_{k ∈ {S}_{t}} {D}_{k} {γ}^{{α}_{k , t}}} ,$$
wherein Dₙ represents a quantity of data samples of the n^{th} terminal device, γ represents an offset parameter for controlling the model aggregation, α_{n,t} represents an aggregation interval of the n^{th} terminal device, Dₖ represents a quantity of data samples of a k^{th} terminal device in Sₜ, and α_{k,t} represents an aggregation interval of the k^{th} terminal device.

15. The method for model training according to claim 1, wherein a network device that sends the first sub-model comprises an edge server, and the edge server is configured to determine, under a first constraint condition, at least one of:
a communication bandwidth of each terminal device performing the model training;
a manner in which a calculation frequency of the edge server is allocated;
a selection of a plurality of terminal devices for determining a first aggregation cycle; or
a plurality of split layers comprising the first split layer.

16. A method for model training, comprising:
transmitting, by a network device, a first sub-model from a global model to a first terminal device, wherein the first sub-model is determined according to a first split layer; and
training, by the network device, a second sub-model in the global model;
wherein and at least one of the following is true:
training of the first sub-model and training of the second sub-model are jointly used to determine a first local model, and the first split layer is determined according to a capability of the first terminal device; or
training duration of the first sub-model is used to determine whether a training round in which the first local model participates in model aggregation is a current training round.

17. A first terminal device, comprising:
at least one processor; and
one or more non-transitory computer-readable storage media coupled to the at least one processor and storing programming instructions for execution by the at least one processor, wherein the programming instructions, when executed, cause the first terminal device to perform operations comprising:
receiving a first sub-model from a global model, wherein the first sub-model is determined according to a first split layer; and
training the first sub-model;
wherein the global model further comprises a second sub-model, and at least one of the following is true:
training of the first sub-model and training of the second sub-model are jointly used to determine a first local model, and the first split layer is determined according to a capability of the first terminal device; or
training duration of the first sub-model is used to determine whether a training round in which the first local model participates in model aggregation is a current training round.

18. The first terminal device according to claim 17, wherein the first terminal device is one of a plurality of terminal devices, a plurality of sub-models received by the plurality of terminal devices are separately determined according to the global model and a plurality of different split layers, the plurality of sub-models comprise the first sub-model, and the plurality of split layers comprise the first split layer.

19. The first terminal device according to claim 17, wherein the first split layer is determined according to a capability level corresponding to the first terminal device, a second terminal device that performs the model training corresponds to a third sub-model, and the first sub-model is greater than the third sub-model in a case of the capability level of the first terminal device being higher than a capability level of the second terminal device.

20. The first terminal device according to claim 17, wherein the first terminal device belongs to a first terminal device set, and all terminal devices in the first terminal device set correspond to a same capability level.
